(19) United States
(12) Patent Application Publication
(10) Pub. No.: US 2009/0141881 A1
(43) Pub. Date: Jun. 4, 2009

(54) Method and Communication System for Activating a Feature of a Communication Terminal

(76) Inventors: Thomas Lederer, Herrsching (DE); Stephan Schaade, Buchloe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/992,800

(22) PCT Filed: Aug. 24, 2006
(86) PCT No.: PCT/EP2006/065635

§ 371 Date: Mar. 28, 2008

(30) Foreign Application Priority Data
Sep. 29, 2005 (DE) 10 2005 046 745.8

(51) Int. Cl. H04M 3/42

(52) U.S. Cl. 379/201.12

(57) ABSTRACT

Activating a feature of a first communication terminal, includes registering first address information that specifies the first communication terminal based on an incoming transmission at the first communication terminal or at a connection controller assigned to the first communication terminal, registering second address information that specifies a sender based on the incoming transmission, checking whether the registered second address information has been assigned for the first address information, and activating the feature when the checking returns a positive result.

### CROSS REFERENCE TO RELATED APPLICATIONS

This application is the US National Stage of International Application No. PCT/EP2006/065635, filed Aug. 24, 2006 and claims the benefit thereof. The International Application claims the benefits of German application No. 10 2005 046 745.8 DE filed Sep. 29, 2005, both of the applications are incorporated by reference herein in their entirety.

### FIELD OF INVENTION

The present invention relates to a method and communication system for activating a feature of a communication terminal.

In known private branch exchanges and in the case of known voice terminals, features of a voice terminal are frequently configured at the respective voice terminal. For example for configuring and activating call forwarding, the “call forwarding” feature is selected via an input field on the voice terminal and a destination directory number entered as the forwarding destination. Call forwarding is in conclusion activated on the voice terminal and can later be deactivated thereon in an analogous manner. What is therein to be understood by the term “call forwarding” is a feature whereby incoming connections will be switched through to a directory number configured as the forwarding destination. Incoming connections will through activation of call forwarding be redirected or forwarded to the forwarding destination or destination directory number.

### BACKGROUND OF INVENTION

Known also is a method for activating a function—comparable in part to call forwarding—of a terminal for a voice terminal that is different therefrom within the scope of a teleworking or home workstation. A directory number of a corporate voice terminal is therein by means of operating steps performed on a computer at the remote workstation assigned to a voice terminal at the remote workstation. Calls to or from the directory number will thereafter be conducted via the voice terminal at the remote workstation. The computer at the remote workstation can access a corporate private branch exchange or the corporate voice terminal for activating the method via, for instance, a TAPI (TAPI: Telephony Application Programming Interface) interface.

From U.S. Pat. No. 6,285,750 B1 it is also known to activate call forwarding by means of an incoming call to a forwarding terminal. Telephone numbers of authorized people who may trigger such call forwarding are specified in a registration unit referred to as the “registry”.

Furthermore from another publication document EP 0 841 797 A2, it is known that call forwarding activation can take place by means of an incoming SMS as is customary in the field of mobile communication systems.

### SUMMARY OF INVENTION

The object of the present invention is to improve activating of a feature for a first communication terminal proceeding from a second communication device.

Said object is achieved by a method and by a communication system having the features of the independent claims.

Advantageous embodiment variants and developments of the invention are disclosed in the dependent claims.

In the inventive method for activating a feature of a first communication terminal, first address information specifying the first communication terminal is registered on the basis of a transmission arriving at the first communication terminal or at a connection controller assigned to the first communication terminal. Second address information specifying a sender of the transmission is furthermore registered and a check performed to determine whether the registered second address information has been stored assigned for the registered first address information. Storing therein takes place particularly in the first communication terminal, the connection controller, or a further central device. The feature will be activated if checking returns a positive result.

The transmission is in particular an incoming voice or multimedia connection, preferably one initiating a call setup, or an incoming text or multimedia message, for example a mobile radio message, known from mobile radio, such as an SMS (SMS: Short Message System) or MMS (MMS: Multimedia Messaging Service) message.

The connection controller is in particular a switching system or private branch exchange, a gateway, or a gatekeeper, with its being possible to link communication terminals and further connection controllers to the connection controller on circuit-oriented or packet-switched principles, on a corded basis or cordlessly.

The first and/or second address information is in particular text information relating to a directory number, a MAC address, an IP address, or an E.164 number according to the associated ITU-T (ITU-T: Standardization Sector of the International Telecommunication Union) recommendation, with the first address information being used preferably in signaling to and/or from the first communication terminal and the second address information in signaling to and/or from the sender of the transmission. The first and/or second address information can furthermore be identifying information, assigned to the respective communication terminal, that can be ascertained from a chip card on, for instance, a company ID card or SIM (SIM: Subscriber Identification Module) card, from a digital certificate, or from biometric data—in particular a fingerprint—at the respective communication terminal.

The first communication terminal is furthermore in particular a circuit-switched voice terminal such as a telephone, a packet-oriented IP (IP: Internet Protocol) voice terminal, a data terminal such as a fax machine, or what is termed a soft client as a telephony application running within a data processing device or PDA (Personal Digital Assistant). The first communication terminal is preferably a constituent part of a communication system or private branch exchange in a company's or organization's communication network. The sender is just such a communication terminal or, furthermore, preferably a communication terminal outside said communication system or network, in particular a mobile radio terminal or fixed network device coupled to the communication network via a trunk line.

The sender is advantageously a mobile telephone and the first communication terminal advantageously a corporate telephone of a common user and permanently assigned to him/her so that the sender can be authenticated inventively by way of a check performed on that assignment. Said assignment can therein preferably take place using employee data and based on what is termed a Directory Service frequently already present in existing corporate networks so that a frequently already existing infrastructure can be used by means of the invention.

The first communication terminal's feature is activated by means of the inventive method in particular in the first communication terminal, the connection controller, a private branch exchange, or a gatekeeper. Examples of a feature that can advantageously be activated by means of the inventive method are conditional or unconditional call forwarding to a deputy communication terminal or to an alternative communication terminal of the user. The feature is furthermore, for example, an automatic answering function of the first communication terminal, a teleworking function for logically substituting a company's internal communication terminal with one external to the company, acoustic room monitoring by the first communication terminal, reinitializing—which is to say resetting—the first communication terminal, or logging on the first communication terminal to a connection controller or, as the case may be, registering said terminal therewith.

The address information can be conveyed within the scope of the transmission by means of, for example, CLIP (Calling Line Identification Presentation) or explicitly interrogated by the first communication terminal or the connection controller.

The invention is advantageous in that a feature, in particular call forwarding, can be initiated for the first communication terminal by a further communication terminal, namely the sender. It is further advantageous that evaluating of the assignment between the first and second address information renders explicit authenticating by, for instance, entering an access number and password superfluous because a feature can be activated only for communication terminals thus mutually assigned. Configuring of the assignment could therefore preferably be for that purpose changeable only via safeguarded mechanisms, for example by deriving the assignment from a personnel database or having it administered manually by trusted administrators.

It is furthermore advantageous that the feature can be activated in a few, simple steps. Those are, for example, just sending a call or an SMS message from a mobile telephone as the sender to the first communication terminal.

It is furthermore advantageous that connection costs can be kept low because costs will be incurred only for an SMS message or for a short activation call, preferably with incoming ringing for the incoming call not being extended by the connection controller to the first communication terminal and its thereby being made possible to activate the inventive method without any connection costs.

When the feature has been activated it is preferably activated for an ensuing connection setup from a further communication terminal to the first communication terminal. Call forwarding to a mobile radio device will thus, for example, be activated by inventive activating so that for any subsequently incoming calls from any further communication terminals to the first communication terminal the respective call will be forwarded to the mobile radio terminal. Call forwarding will thus in this instance become effective for all incoming connections following activation but not for the transmission initiating it.

The feature can in particular remain continuously effective either until later deactivated by means of a new transmission initiating the inventive method or when a set time has expired.

Preferably during a transmission due to a text message, for example an SMS message from a mobile radio network, control information for controlling the feature can owing to the positive check result be registered from useful and/or signaling data of the incoming transmission. Thus, for example, controlling instructions such as “activate AA” for activating an automatic answering function or “activate call fwd: 31552” for setting up call forwarding to the specified extension number can be contained in the SMS message's useful text. The first and/or second address information can likewise also be contained in the useful text or determined from signaling data of the SMS message.

### BRIEF DESCRIPTION OF THE DRAWINGS

An exemplary embodiment of the invention is explained in more detail below with reference to a drawing, in which in schematic representation:

FIGS. 1-4 show a communication system having a plurality of server components and communication terminals at different steps of the method or in different implementation variants of the inventive method, and

FIG. 5 is a flowchart showing the main steps of the method for inventive activation of call forwarding.

### DETAILED DESCRIPTION OF INVENTION

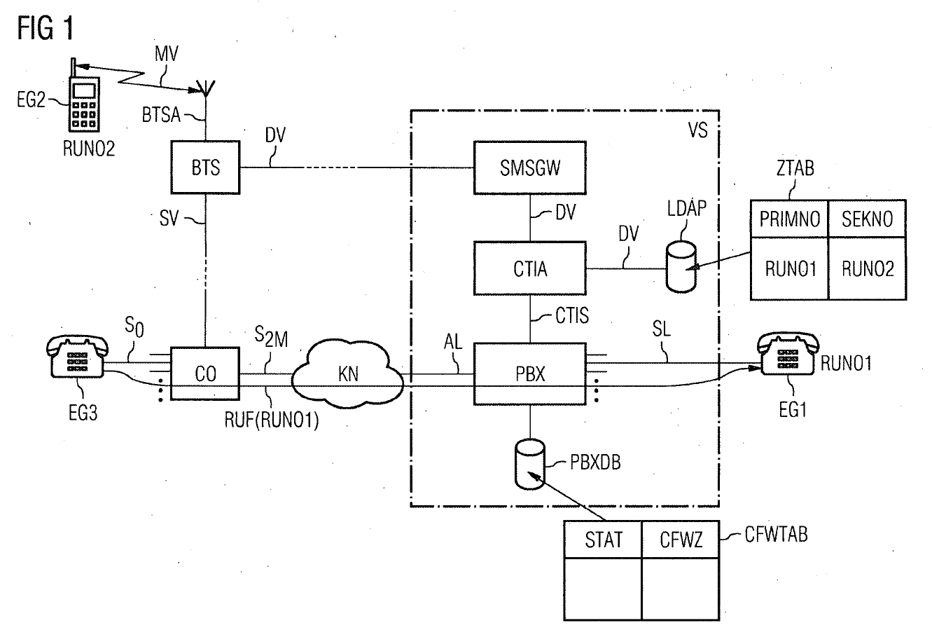

FIGS. 1-4 are schematics of a communication system for communicating by voice in realtime having a private branch exchange PBX shown as a rectangle and a first telephone EG1 coupled as the first communication terminal via a subscriber line SL to the private branch exchange PBX. The communication system is, for example, a private communication network in the case of which a plurality of telephones can—like the first telephone EG1—be connected to the private branch exchange PBX.

It is furthermore assumed that the private branch exchange PBX is connected via a trunk line AL and one or a chain of connection controller(s) to a second telephone EG2 belonging to a mobile radio network and to a third telephone EG3 belonging to a public communication network. More precisely, the third telephone EG3 is coupled via an ISDN (ISDN: Integrated Services Digital Network) line S₀ to a public central office CO, with that being in turn coupled via what is termed a primary rate multiplex access S_{2M} to a communication network KN and, further, via the trunk line AL to the private branch exchange PBX. The second telephone EG2—a mobile telephone—can be coupled to a base station BTS via its base station antenna BTSA over a mobile radio link MV styled a “blitz”, depending on the radio cell in which the mobile telephone is located.

The base station BTS is coupled via a voice tie line SV, not specified in further detail within the scope of the exemplary embodiment, to the public central office CO. For transmitting text and multimedia messages from mobile radio terminals let furthermore in a simplified manner a coupling of the base station BTS be provided via a data tie line DV to a data network indicated only by a dotted line.

The ISDN line S₀, primary rate multiplex access S_{2M}, trunk line AL, and mobile radio link MV are in the present exemplary embodiment characterized by being able to convey directory number information of a sending user via CLIP.

The private branch exchange PBX is part of an inventive connection controller VS, shown as a rectangle with dashed outlining, which further includes an SMS gateway SMSGW, a CTI application CTIA (CTI: Computer Telephony Integration), a Directory Service LDAP, and a private branch exchange database PBXDB belonging to the private branch exchange PBX. The SMS gateway SMSGW is therein coupled via the aforementioned data network and aforementioned data tie line DV to the base station BTS and via a further data tie line DV to the CTI application CTIA. Those are in turn coupled via a CTI interface CTIS to the private branch exchange PBX and via a further data tie line DV to the Directory Service LDAP.

The first telephone EG1 as the inventive first communication terminal is coupled via the subscriber line SL to the private branch exchange PBX, via which it is controlled. The first telephone EG1 is assigned a first directory number RUNO1, the second telephone EG2 as the inventive sender is assigned a second directory number RUNO2.

The aforementioned physical connections and lines are indicated by continuous drawn lines; messages and logical connections—designated RUF, AKTRUF, SETZ, PRUEF, AKTSMS, or I in the following—are indicated by continuous drawn lines having an arrow at one end or both.

Internal private branch exchange user-, terminal- and/or connection-related data is stored by the private branch exchange database PBXDB. Said data is in particular a call forwarding table CFWTAB in which is stored an assignment of terminal information STAT to a call forwarding destination CTWZ, with the terminal information STAT able to be information such as a line number, directory number, or terminal identification number identifying a communication terminal.

User-related data is stored and administered by the Directory Service LDAP, with the data of the Directory Service LDAP able to be configured and/or interrogated via an LDAP (LDAP: Lightweight Directory Access Protocol) interface (not shown). That is advantageous particularly in that employee data such as name, directory number, mobile radio number, employee number, e-mail address, etc. is within companies frequently filed centrally in a database of a Directory Service and said data can within the scope of the invention be further utilized. A database originally created for other purposes can hence be read out for the invention. That will diminish the configuration effort and reduce potential errors due to incorrect user data or to error-prone, manual maintenance of the user data or, as the case may be, inventive assigning.

The Directory Service LDAP includes in particular an assignment table ZTAB in which is stored an assignment of a primary directory number PRIMNO to a secondary directory number SEKNO. For the present exemplary embodiment the first directory number RUNO1 of the first telephone EG1 is stored assigned as the primary directory number PRIMNO and the second directory number RUNO2 of the second telephone EG2 is stored assigned as the secondary directory number SEKNO in the assignment table ZTAB. Said assignment is based on the assumption by way of example that the second telephone EG2 is a mobile radio device of the user of the first telephone EG1 and the first telephone EG1 is a workstation terminal of said user.

The already cited coupling between the CTI application CTIA and private branch exchange PBX via the CTI interface CTIS is implemented by means in particular of the CSTA (CSTA: Computer Supported Telecommunications Application) protocol that has been standardized by the ECMA (European Computer Manufacturers Association) and via which the CTI application CTIA is informed about the call processing statuses and status changes of the private branch exchange PBX. The CTI application CTIA can be implemented on a separate computer, in the private branch exchange PBX, or on a workstation computer.

The private branch exchange PBX, the first telephones EG1, and the third telephone EG3 are provided for circuit-switched realtime communication for voice; the second telephone EG2 further supports non-realtime communication for data via SMS text messages.

As an alternative to the embodiment of the illustrated first telephone EG1 as a fixed network telephone, it can furthermore be embodied as a telephone application −what is termed a soft client—running on a workstation computer or as a mobile communication terminal. The private branch exchange PBX can furthermore as an alternative to the embodiment variant shown be based on packet-oriented principles, with its being possible for a packet-oriented private branch exchange PBX or else a gatekeeper, gateway, or communication server to be integrated in the communication system.

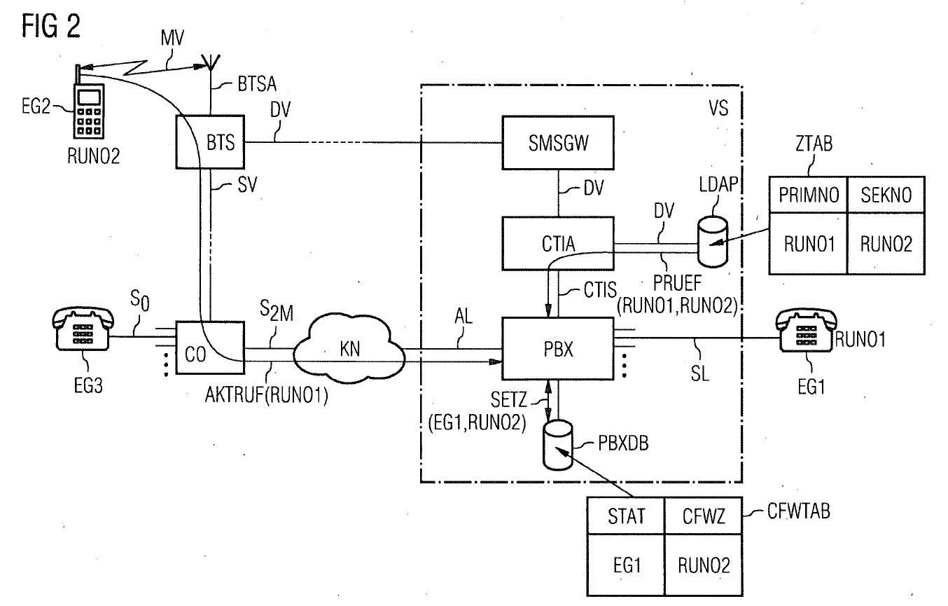

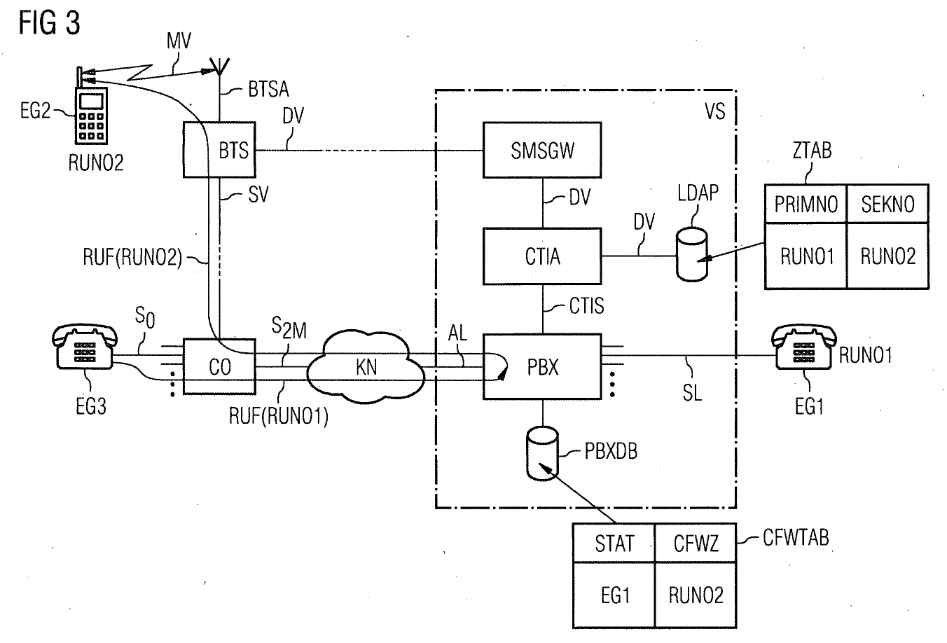

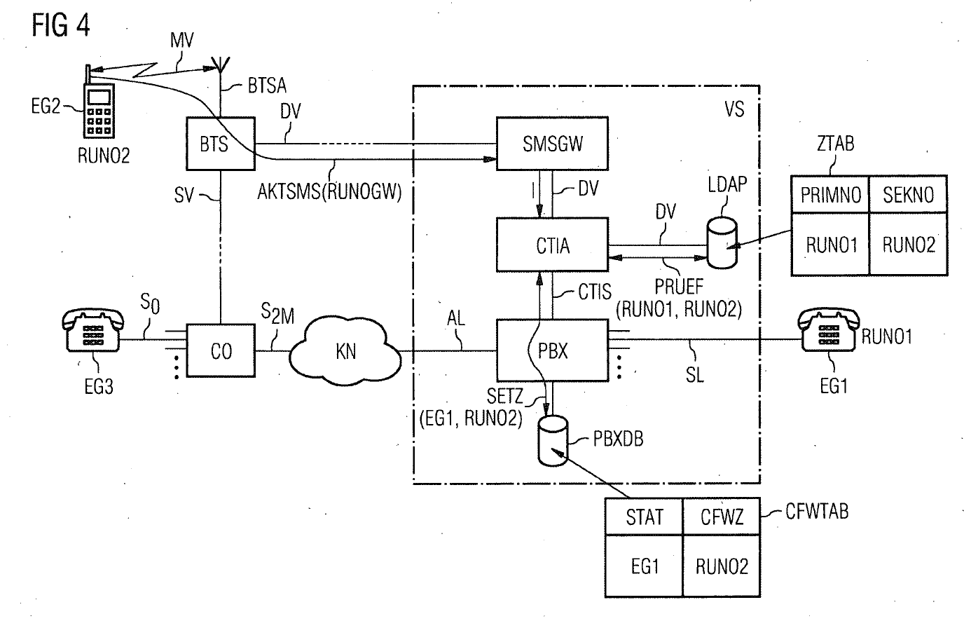

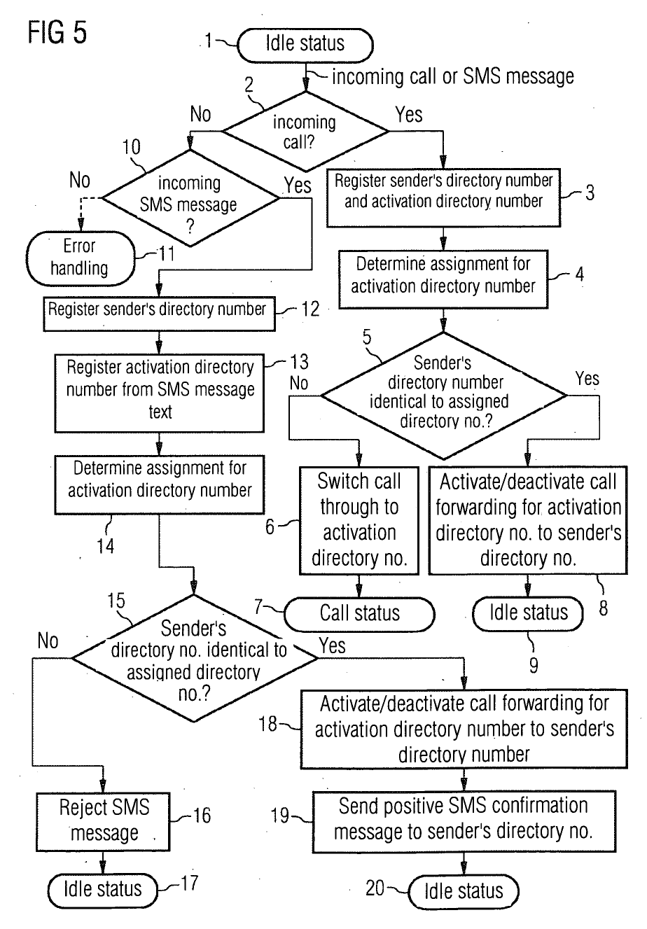

Shown in FIG. 1 is an initial situation for FIGS. 2 and 4 having a configuration prior to the inventive method's initializing, with the assignment table ZTAB being already configured with the cited data record for the first directory number RUNO1 for implementing an inventive activation of call forwarding as the feature. FIGS. 2 and 4 show two alternative embodiments for inventive activating of call forwarding and FIG. 3 shows a call setup following activating of said kind. The steps of the method are explained below with the aid of FIGS. 1 to 4, with reference being in part made to the flowchart in FIG. 5 for the connection controller VS.

Proceeding from an idle status of the connection controller VS (status 1 in FIG. 5), call setup signaling RUF takes place in FIG. 1 proceeding from the third telephone EG3 via the public central office CO to the private branch exchange PBX, with the request to set up a connection to the first directory number RUNO1 (status 2 in FIG. 5). The directory number of the sending third telephone EG3 is therein conveyed by means of CLIP within the scope of call setup signaling RUF to the private branch exchange PBX. Said exchange registers said information (statuses 3 and 4 in FIG. 5) and therewith initializes a check to determine whether there is an entry in the assignment table ZTAB having an assignment to the directory number of the third telephone EG3 (not shown in FIG. 1; status 5 in FIG. 5) for the addressed first directory number RUNO1. In the present exemplary embodiment said check supplies at this step of the method a negative check result. Activating of a feature—which would incidentally not be at all desirable—will thereupon be rejected according to the inventive method.

The call forwarding table CFWTAB is furthermore—as is customary in known private branch exchanges—interrogated by the private branch exchange PBX for the addressed call destination RUNO1 (not shown), with the table being empty at this step of the method and so supplying a negative check result. It will be recognized on the basis of said negative check result that no call forwarding is required. The private branch exchange PBX thereupon signals the incoming call to the first telephone EG1 by means of call setup signaling RUF (statuses 6 and 7 in FIG. 5).

Proceeding from the configuration shown in FIG. 1, FIG. 2 shows activating of call forwarding from the first telephone EG1 to the second telephone EG2 initiated by the second telephone EG2. A call is for that purpose initiated via the second telephone EG2 to the first telephone EG1 with addressing to the first directory number RUNO1. Call setup signaling AKTRUF for activating call forwarding as the inventive transmission is therein routed from the second telephone EG2 via the mobile radio link MV, the base station BTS, the public central office CO, and the communication network KN to the private branch exchange PBX, and hence to the connection controller VS (status 2 in FIG. 5). The signaled first directory number RUNO1 of the called first telephone EG1 and the sender's second directory number RUNO2 conveyed by means of CLIP within the scope of call setup signaling AKTRUF are registered by the private branch exchange PBX (statuses 3 and 4 in FIG. 5).

If signaling of the sender's directory number within the scope of call setup signaling AKTRUF does not take place or is not possible, said number can alternatively be explicitly interrogated by the private branch exchange PBX by way of back-signaling to the second telephone EG2.

The CTI application CTIA monitors the private branch exchange PBX for status changes and any events that arrive. In the case of an incoming call such as call setup signaling AKTRUF the registered, call-related data such as the first and second directory number RUNO1, RUNO2 is transmitted by the private branch exchange PBX via the CTI interface CTIS to the CTI application CTIA. The CTI application CTIA receives and registers said conveyed data and initiates interrogating of the Directory Service LDAP to determine whether a data record exists therein for the first directory number RUNO1 in the assignment table ZTAB and whether an assignment of the first directory number RUNO1 to the second directory number RUNO2 is stored in said record (status 5 in FIG. 5).

In the present exemplary embodiment that is so. That is made known to the CTI application CTIA and further to the private branch exchange PBX in a positive acknowledgement for conveying the positive check result. If, conversely, contrary to the present exemplary embodiment, either no entries were to be found in the assignment table ZTAB for the first directory number RUNO1 or one or more entries were to be found but none of them having an assignment to the second directory number RUNO2, then a negative acknowledgement would be signaled to the private branch exchange PBX.

The above-described communication between the private branch exchange PBX, the CTI application CTIA, and the Directory Service LDAP by means of an interrogation connection PRUEF is visualized in FIG. 2 as a double arrow between the private branch exchange PBX and the Directory Service LDAP, with the interrogation connection PRUEF being set up via the CTI application CTIA.

Owing to the positive check result concerning the assignment of the second directory number RUNO2 to the first directory number RUNO1 in the assignment table ZTAB, call forwarding of the first telephone EG1 to the second directory number RUNO2 will be activated initiated by the CTI application CTIA or private branch exchange PBX (status 8 in FIG. 5). The relevant feature is set in the private branch exchange PBX and configured in the private branch exchange database PBXDB. The latter is illustrated in FIG. 2 by a transfer SETZ in which information about the affected terminal device—in this case the first telephone EG1—and about a destination directory number—in this case the second directory number RUNO2—is transferred to the private branch exchange database PBXDB and stored mutually assigned there in the call forwarding table CFWTAB.

The call setup is thereupon interrupted or, as the case may be, terminated by the private branch exchange PBX or the CTI application CTIA. That is signaled acoustically to the calling, second telephone EG2 by means of an announcement or just a known call tone, for example a busy tone.

In none of the aforementioned steps of the method is it signaled to the first telephone EG1 that there is an incoming call. All signaling to the first telephone EG1 is suppressed. An announcement or ringing tone can alternatively also be initiated at the first telephone EG1 as an acknowledgement to make activating of call forwarding known at the first telephone EG1.

The connection controller VS and in particular the private branch exchange PBX can finally assume an idle status (status 9 in FIG. 5). Any ensuing calls to the first telephone EG1 will be signaled by the private branch exchange PBX through an evaluation of the call forwarding table CFWTAB to the call forwarding destination CFWZ stored therein, meaning to the second directory number RUNO2 and hence to the second telephone EG2. That is shown by way of example in FIG. 3.

The method presented is advantageous in that call forwarding or another feature for a registered communication terminal can with no further authenticating or certifying be initiated for just one further communication terminal registered in advance for said registered communication terminal.

That is advantageous particularly for resolving a frequently occurring problem when company employees leave their workplace in the company having forgotten to redirect telephone calls arriving during their absence to their mobile radio terminal. They will now, given a suitably configured private branch exchange PBX, be able to activate appropriate call forwarding simply by means of a call from their mobile radio terminal to their corporate terminal. They will thus be furnished with a simple and at the same time manipulation-proof way to activate call forwarding to their mobile radio terminal.

It is further advantageous that call forwarding can be activated free of charge, there being no provision in the inventive method for answering the transmission initiating activation.

Especially when one of a plurality of available features is to be selected by the user initiating an activation transmission it can be advantageous to offer the initiating user a feature selection option. That can be done by, for example, integrating an announcement service having a key control or voice control. Said announcement service can offer the calling user the available features acoustically for making a selection. The user can then, depending on the specific embodiment, press a key or use voice input to select the feature, which will thereupon be activated by the connection controller.

A separate directory number able to be used for activating features can furthermore alternatively be identified in the private branch exchange PBX as the access number. A directory number specifying a terminal for which the feature is to be activated can then be determined either by way of an announcement service—as described above—or through extraction from appended directory number digits on the access number. That alternative variant will prove advantageous since just one directory number, the access number, will have to be monitored with regard to incoming calls.

Deactivation of call forwarding and changeover to the previously assumed basic condition is effected advantageously by setting up another activation connection from the second telephone EG2 to the first telephone EG1. Changeover between an active and an inactive status of the feature is thus effected by means of the activation transmission.

Shown following in FIG. 3 is a connection attempt from a third telephone EG3 to the first telephone EG1, with the call forwarding feature to the second telephone EG2 having been activated. Dialing the first directory number RUNO1 on the third telephone EG3 will cause call setup signaling RUF to be set up from the third telephone EG3 via the public central office CO and the communication network KN to the private branch exchange PBX. First an entry in the assignment table ZTAB is interrogated in the private branch exchange PBX for the first directory number RUNO1 as the call's destination directory number and the directory number of the third telephone EG3 (not shown). Said interrogation is negatively acknowledged in the present exemplary embodiment. The private branch exchange PBX then processes the incoming call using known mechanisms and checks in particular by means of the call forwarding table CFWTAB whether there is an entry for the first telephone EG1, the one requiring to be called. That is so in the present exemplary embodiment. The destination of call forwarding—in this case the second directory number RUNO2—is read out from the call forwarding table CFWTAB and call setup signaling RUF then forwarded to said destination.

Call setup signaling RUF with a new destination directory number—the second directory number RUNO2—is thus conveyed as the connection destination by the private branch exchange PBX via the communication network KN, the public central office CO, the base station BTS, and the mobile radio link MV to the second telephone EG2. An incoming call will consequently be signaled visually and acoustically on the second telephone EG2 and, on being answered, switched through to there.

As an alternative to FIG. 2 FIG. 4 illustrates a kind of feature activation that uses an SMS message as the text message for the inventive transmission for activating the feature. An SMS message is for that purpose entered on the second telephone EG2 or a prepared SMS message is called up from a memory belonging to the second telephone EG2 and sent to the base station BTS. The SMS message includes in the present exemplary embodiment a text “AKT RUFUML: RUNO1” as useful data and hence as control information for controlling feature activation, with “AKT” and “RUFUML” being keywords for activating call forwarding and RUNO1 being the first directory number RUNO1 of the first telephone EG1.

The SMS message is routed as the activating message AKTSMS to the SMS gateway SMSGW of the connection controller VS by the base station BTS via a connection path that is not further specified (status 10 in FIG. 5). Said SMS gateway SMSGW is addressed as the central message office via a central gateway directory number RUNOGW. The required feature—call forwarding—, the required action—activating—, and the directory number of the communication terminal for which the feature is to be activated—RUNO1—are determined from the useful data text as a result of the arrival of the activating message AKTSMS. The directory number RUNO2 of the sending, second telephone EG2 is furthermore determined and registered from signaling data of the activating message AKTSMS (statuses 12 and 13 in FIG. 5).

An initiating message I containing the cited information is subsequently conveyed by the SMS gateway SMSGW to the CTI application CTIA. An interrogation connection PRUEF is set up by said application for determining whether there is a common entry in the assignment table ZTAB of the Directory Service LDAP for the registered, first and second directory number RUNO1, RUNO2 (statuses 14 and 15 in FIG. 5). In the present exemplary embodiment that is so, which is notified to the CTI application CTIA by means of a positive acknowledgement from the Directory Service LDAP as confirmation of the existence of an assignment between the first and second directory number RUNO1, RUNO2.

The connection controller VS would in the event of a negative acknowledgement only reject the SMS message that has arrived (status 16 in FIG. 5) and assume an idle status (status 17 in FIG. 5).

As a result of the positive acknowledgement the private branch exchange PBX is instructed by the CTI application CTIA to set up call forwarding from the first telephone EG1 to the second directory number RUNO2 of the second telephone EG2, initiating call forwarding, in accordance with the registered information, and to activate it—not shown. The CTI application CTIA can as an alternative thereto and shown in FIG. 4 have direct access to the private branch exchange database PBXDB controlling the features. The registered information is for that purpose transferred by means of the transfer SETZ to the call forwarding table CFWTAB. Call forwarding from the first telephone EG1 to the second directory number RUNO2 is thereby activated in said table (status 18 in FIG. 5).

It is optionally possible then for the SMS gateway SMSGW to be prompted by the CTI application CTIA to send a confirmation SMS message to the second directory number RUNO2 (status 19 in FIG. 5). That step will terminate activating of the “call forwarding” feature. The connection controller VS can assume an idle status (status 20 in FIG. 5).

A configuration corresponding to FIG. 3 in which a call setup from a further communication terminal such as the third telephone EG3 to the first telephone EG1 is forwarded by the private branch exchange PBX to the second telephone EG2 will have arisen as a result of the steps of the method illustrated with the aid of FIG. 4.

Activating by means of a text message will therein be advantageous in that a command syntax allowing a large number of different features to be activated or deactivated and having prespecified keywords can be defined for the text message. Thus, for instance, call forwarding can via a useful data text “AKT RUFUML: RUNO1 TO RUNOx” be activated for the first telephone EG1 having the first directory number RUNO1 to any directory number RUNOx. It is furthermore possible, for example, by means of a useful data text “DEAKT AB: RUNO1” to deactivate an automatic answering machine function for the first telephone EG1. The result is a very easy-to-expand method for activating features.

Notwithstanding said flexibility, there is still an implicit authorization check due to the interrogation of the assignment table ZTAB so that a feature cannot be activated from a terminal device assigned to an unauthorized person.

To meet enhanced security requirements it can be provided in a basic configuration of a connection controller VS for no features to be able to be activated in the described manner from a remote communication terminal via an incoming SMS message. The inventive method for activating features will not be enabled by the connection controller until an SMS enabling message has been conveyed by means of, for example, the keyword “enable” and/or an enabling code as the useful data. The method can alternatively be expanded in such a way that remote activating of features can be blocked or released on the first telephone EG1 by entering a code or selecting a function.

Be it further noted that activating by means of an SMS message can also be generalized in such a way that said activating can take place under the control of a workstation computer or PDA, with the computer or PDA being able to be coupled to a network via a radio link or cable link. Conveying to the connection controller VS can therein be performed via, for instance, a packet-switched data network such as the internet.

It will furthermore prove advantageous when an SMS message is used that only low conveying costs will be incurred. It is possible as an alternative to the exemplary embodiment shown for not just a gateway directory number RUNOGW to be provided in the SMS gateway SMSGW as the target address for the SMS activation message but a separate SMS access number corresponding to the respective communication terminal's telephone number for each such terminal administered by the connection controller VS. Thus, for example, the SMS activation message could be addressed to the first directory number RUNO1 and processed through interacting between the SMS gateway SMSGW and private branch exchange PBX.

As an alternative to an SMS text message it is possible also to use a multimedia message such as an MMS for activating a feature, with controlling able to be performed by means also, alongside text, of conveyed graphics, tones and/or voice, with voice, tone, and/or graphics analysis able possibly to be used in the connection controller vs.

It is advantageous in the case of the method presented within the scope of the drawing that user prompting and/or the entry of a password is not necessary, although both can easily be integrated in the method if considered advantageous in an implementation variant. The method's proof against manipulation, provided the sender's directory number is conveyed by means of CLIP and administering of the assignment table ZTAB is safeguarded or derived from a central employee database, is furthermore a major advantage of the invention.

Time information—in particular a date and/or time of day for activation—can in an expansion advantageously additionally be assigned in a data record in the assignment table ZTAB and compared within the scope of checking the assignment in the assignment table with reference time information. That will enable a feature to be made available for a specific period of time only. The assignment table ZTAB can as an alternative to the embodiment variant shown moreover be stored in a central memory or in the private branch exchange database PBXDB belonging to the communication system.

Although the invention has been explained in the exemplary embodiment with the aid of voice terminals, the communication terminals can also be video or multimedia terminals or data terminals such as fax machines. The first telephone EG1 can furthermore be a software telephony application on a workstation computer or it can be a PDA. A circuit-switched or packet-oriented method can furthermore be employed as the communication method and the telephones EG1, EG2, EG3 can be circuit-switched or packet-oriented cabled or mobile terminals.

The second telephone EG2 initiating the method can, generally considered, be coupled to a public or private communication network, a mobile radio network, an ISDN network, a public or private data network, or a radio data network, provided the relevant network allows a connection from the second telephone EG2 to the first telephone EG1.

1.-13. (canceled)

14. A method for activating a feature of a first communication terminal, comprising:
registering first address information that specifies the first communication terminal based on an incoming transmission at the first communication terminal or at a connection controller assigned to the first communication terminal, the incoming transmission is a text message or multimedia message;
registering second address information that specifies a sender based on the incoming transmission;
checking whether the registered second address information has been assigned for the first address information; and
activating the feature when the checking returns a positive result.

15. The method as claimed in claim 14,
wherein the first and second address information are registered in a central message office, and
wherein the activating the feature is initiated in the first communication terminal or connection controller by the central message office based on the incoming transmission.

16. The method as claimed in claim 14, wherein when a positive check occurs control information that controls the feature is obtained from user data or signaling data of the incoming transmission.

17. The method as claimed in claim 14, wherein when a positive check occurs control information that controls the feature is obtained from user data and signaling data of the incoming transmission.

18. The method as claimed in claim 14, wherein the first communication terminal is a receiver of the transmission and is addressed via the first address information.

19. The method as claimed in claim 14, wherein when a positive check is suppressed an acoustic, visual display or combination acoustic and visual display is provided for an incoming transmission at the first communication terminal.

20. The method as claimed in claim 14, wherein the feature is call forwarding.

21. The method as claimed in claim 20,
wherein a connection addressed to the first communication terminal is after activating of call forwarding forwarded via addressing to the second address information to a further communication terminal specified by the second address information.

22. The method as claimed in claim 20,
owing to the positive check result a destination directory number, conveyed via the transmission, for call forwarding is registered and call forwarding activated to the destination directory number.

23. The method as claimed in claim 14, wherein the second address information is conveyed within the scope of the transmission or the second address information is interrogated from the sender of the transmission.

24. The method as claimed in claim 14, wherein a text or multimedia message confirming activation of the feature is after activation thereof conveyed by the connection controller or first communication terminal to the second address information.

25. The method as claimed in claim 14, wherein changing over between an active and inactive status of the feature is effected through activating of the feature.

26. A communication system for activating a feature of a first communication terminal, comprising:
a database having an assignment table including a first assigned address associated with a second assigned address; and
a connection control assigned to the first communication terminal,
wherein the connection control:
registers first address information that specifies the first communication terminal based on an incoming transmission, and registering second address information that specifies a sender based on the incoming transmission,
checks whether the registered second address information has been assigned for the first address information, and
activates the feature when the checking returns a positive result.
